(19) United States
(12) Patent Application Publication
(10) Pub. No.: US 2015/0283883 A1
(43) Pub. Date: Oct. 8, 2015

(54) Air Freshener and Packaging Therefor

(71) Applicant: Hopkins Manufacturing Corporation, Emporia, KS (US)

(72) Inventor: Pieter Schouten, Berkley, CA (US)

(73) Assignee: HOPKINS MANUFACTURING CORPORATION, Emporia, KS (US)

(21) Appl. No.: 14/679,528

(22) Filed: Apr. 6, 2015

Related U.S. Application Data
(60) Provisional application No. 61/975,269, filed on Apr. 4, 2014.

(51) Int. Cl. B60H 3/00; B65D 75/32

(52) U.S. Cl. CPC B60H 3/0028; B65D 75/327; B60H 2003/0042

(57) ABSTRACT

An air freshener including a pair of opposed legs extending in spaced relation to one another such that a space is defined therebetween that is adequate for attaching the air freshener to the louver of an air vent in an automobile with the two legs straddling in contacting relation thereto. The air freshener further includes a scent absorbing material and a scented core. The scent absorbing material is positioned distally from the scented core so that the air passing through the air vents and over the air freshener is first exposed to the odor absorber to eliminate at least a portion of the odor present in the air stream prior to the air passing over the scented core which disperse fragrance into the automobile's cabin.

### REFERENCE TO RELATED APPLICATION

The present application relates to U.S. Provisional Patent Application Ser. No. 61/975,269, filed in the United States Patent and Trademark Office on Apr. 4, 2014.

### BACKGROUND

1. Field of Invention

The present invention relates generally to automotive air fresheners and packaging therefor.

2. Background of Art

Automotive air fresheners are used to cleanse and refresh air within an automobile, typically through the emission of an odorant. Odorants may be embedded within materials, such as plastic or paper, and formed in an ornamental shape, sometimes symbolic/representative of the scent the material emits, and provided with suitable fastening mechanisms to permit the hanging from a rear view minor, radio knob, or other anchor point within the automobile.

While some air fresheners will continuously emit a suitable amount of scent merely through exposure to the air, the odorant in other fresheners may require more rapid movement of air over the surface that has been embedded with the odorant in order to emit the scent. Regardless, once exposed to the air, the odorants will begin emission. It is therefore desirable to maintain the odorant in a sealed environment until its employment is desired.

### OBJECTS AND ADVANTAGES

It is a principal object and advantage of the present invention to provide a package of automotive air fresheners that may be distributed in a manner that maintains each air freshener in a sealed environment until it is to be used.

It is another object and advantage of the present invention to provide an air freshener for mounting to the air vent of an automobile and that includes two separate sources of odorant.

Other objects and advantages of the present invention will in part be obvious and in part appear hereinafter.

### SUMMARY OF THE INVENTION

In accordance with the foregoing objects and advantages, the present invention provides a package for air fresheners comprising a bubble pack that includes a bubble space for each air freshener in the package, and a foil backing that independently seals each of the bubbles with respect to the others. Each air freshener is positioned within its respective bubble such that it extends longitudinally across the bubble and a user is able to externally access and manipulate the tip of one leg of the air freshener to penetrate and open the foil backing relative to that particular bubble and without compromising the sealed environment of the remaining bubbles.

Each air freshener comprises a pair of opposed legs extending in spaced relation to one another such that a space is defined therebetween that is adequate for attaching the air freshener to the louver of an air vent in an automobile with the two legs straddling in contacting relation thereto. One of the two legs is noticeably longer than the other and its outwardly and front facing surfaces are appropriately shaped to securely receive an odor absorbing material strip. The odor absorbing strip includes a pocket formed in its leading end that engages and receives the front end of the leg therein, thus securely attaching the strip to the leg. In addition, the leg has two posts extending upwardly therefrom, and the material strip includes two correspondingly shaped and positioned bore holes that receive the posts therein to further reinforce the interconnection between the strip and the leg.

Another feature of the air freshener comprises a fragrance containing core (“scented core”) that snappingly engages a support frame that is positioned at the proximal ends of the legs. The support frame includes open spaces defined by a bridge that extends diagonally across the frame's open center and provides a series of edges that serve as anchor points for the scented core, as well as a post that extends upwardly from the center of the bridge. The scented core includes the core body, a bored opening formed in the body's underside and adapted to securely engage the post formed on the bridge, and a pair of flanges adapted to snappingly engage the edges of the bridge further secure the interconnection between the support frame and the scented core. In use, once the air freshener is attached to the louver of an air vent, the air passing over the scented core will facilitate emission of the fragrance into the automobile's interior. In addition, the spaces defined by the bridge further serve as louvers directing the air flow around the scented core. Furthermore, the scented core being positioned at the point closest the passenger compartments within the automobile as is possible with a vent mounted air freshener provides for the air freshener's maximum effect given the quantity of fragrance used in the scented core,

### BRIEF DESCRIPTION OF THE DRAWINGS

The present invention will be more fully understood and appreciated by reading the following Detailed Description in conjunction with the accompanying drawings, in which:

FIG. 1 is a perspective view of an air freshener;

FIG. 2 is an exploded view of an air freshener;

FIG. 3 is a side elevation view of a clip component of an air freshener;

FIG. 4 is an end elevation view of a clip component of an air freshener;

FIG. 5 is a side elevation view of an odor absorber component of an air freshener;

FIG. 6 is a top plan view of an odor absorber component of an air freshener;

FIG. 7 is a perspective view of an absorber component of an air freshener;

FIG. 8 is a bottom plan view of a scented core component of an air freshener;

FIG. 9 is a side elevation view of a scented core component of an air freshener;

FIG. 10 is a perspective view of packaging for the air fresheners;

FIG. 11 is a top plan view of packaging for the air fresheners; and

FIG. 12 is a bottom plan view of packaging for the air fresheners.

### DETAILED DESCRIPTION

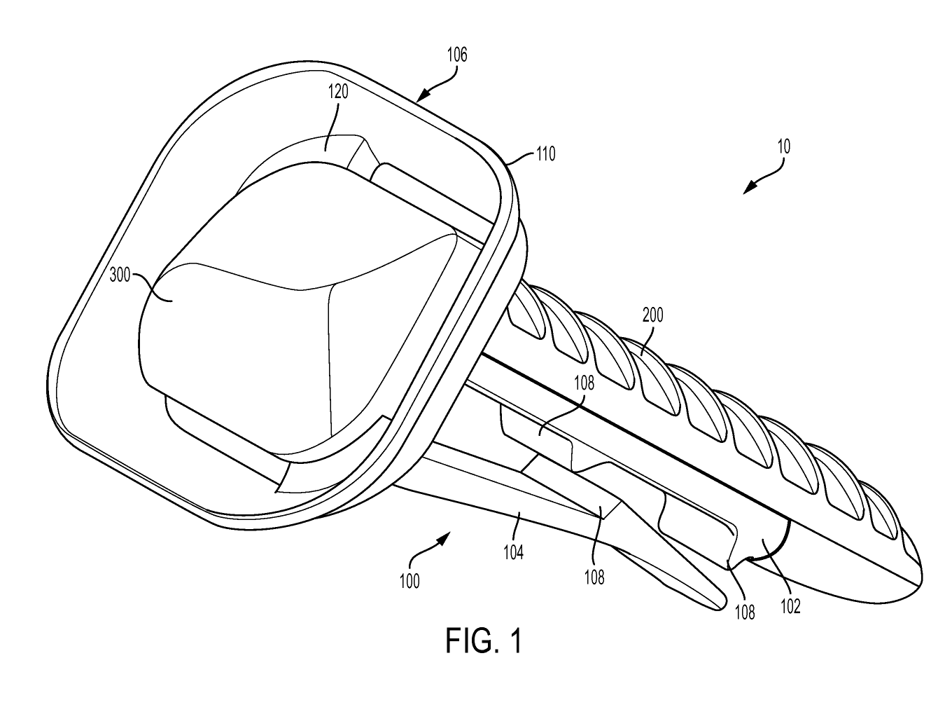

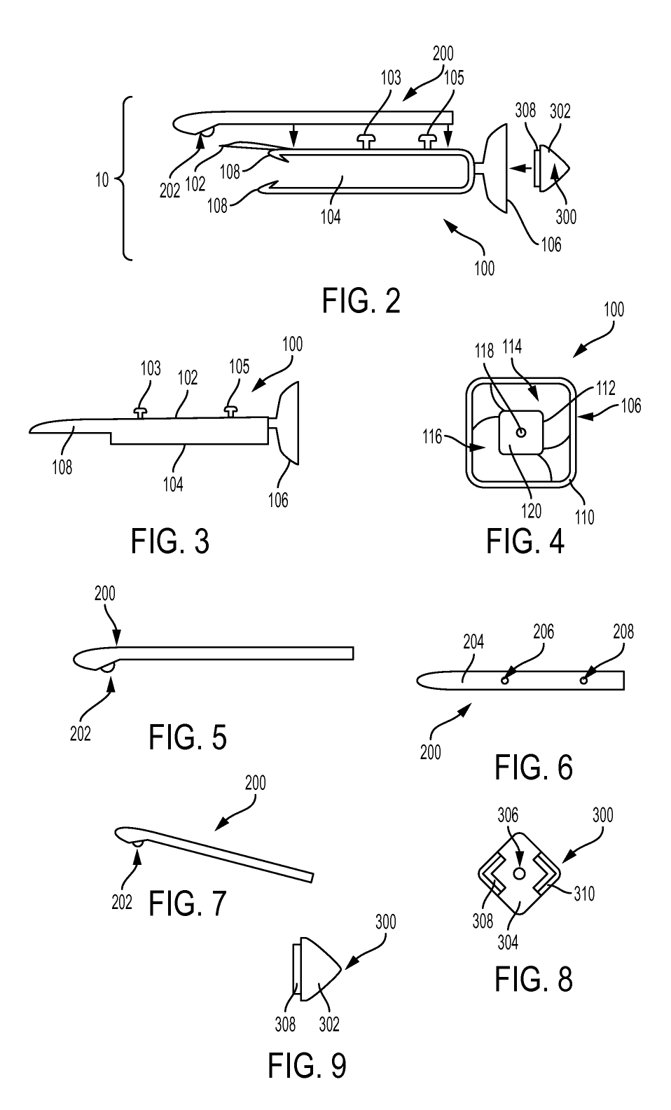

Referring now to the drawings, in which like reference numerals refer to like parts throughout, there is seen in FIG. 1 an air freshener, designated generally by reference numeral 10, generally comprising a body 100, an odor absorber 200, and a scented core 300. Air freshener 10 is adapted to be attached to the louver of an air vent within an automobile in order to emit a fragrant scent into the automobile's interior.

Body 100 of air freshener 10 generally comprises a pair of legs 102, 104 that extend in slightly spaced relation to one another so as to securely accommodate the louver an automobile's air vent therebetween, and a support frame 106 that is positioned at the proximal end of the legs and provides the structural support to the scented core 300. Legs 102 and 104 are resiliently biased relative to one another so as to flexibly vary the distance separating them and thereby accommodate louvers of various thicknesses. Barbs 108 on their inwardly facing surfaces provide secure retention once slid in straddling relation to a louver. Leg 102 is further equipped with a pair of posts 103 and 105 that extend upwardly therefrom.

Support frame 106 extends off the proximal ends of legs 102, 104, and provides the support for scented core 106. An exterior wall 110 and a bridge 112 that extends diagonally across the interior of wall 110 define the structural attributes of support frame 106. The interior surface of wall 110 and the exterior edges of bridge 112 define two openings 114, 116 formed through support frame 106. A post 118 extends upwardly from the center region 120 of bridge 112 and provides a seat for scented core 300, as will be described in greater detail hereinafter.

With reference to FIGS. 5-7, odor absorber 200 comprises an elongated strip of odor absorbing material (or material impregnated with an odor absorbing substance) having a leading end that terminates is a rearward facing pocket 202 adapted to receive the front end of leg 102. The bottom surface 204 of odor absorber 200 includes a pair of bored openings 206, 208, formed therein that are positioned and sized to receive posts 103 and 105, respectively, therein, to assist in securely interconnecting odor absorber 200 to leg 102.

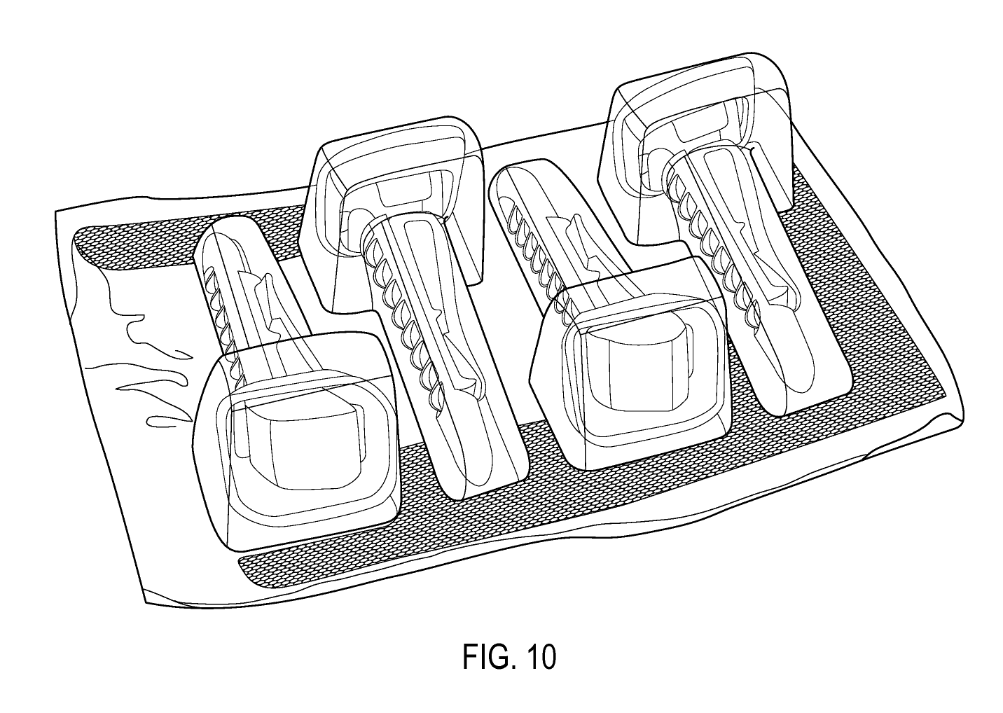

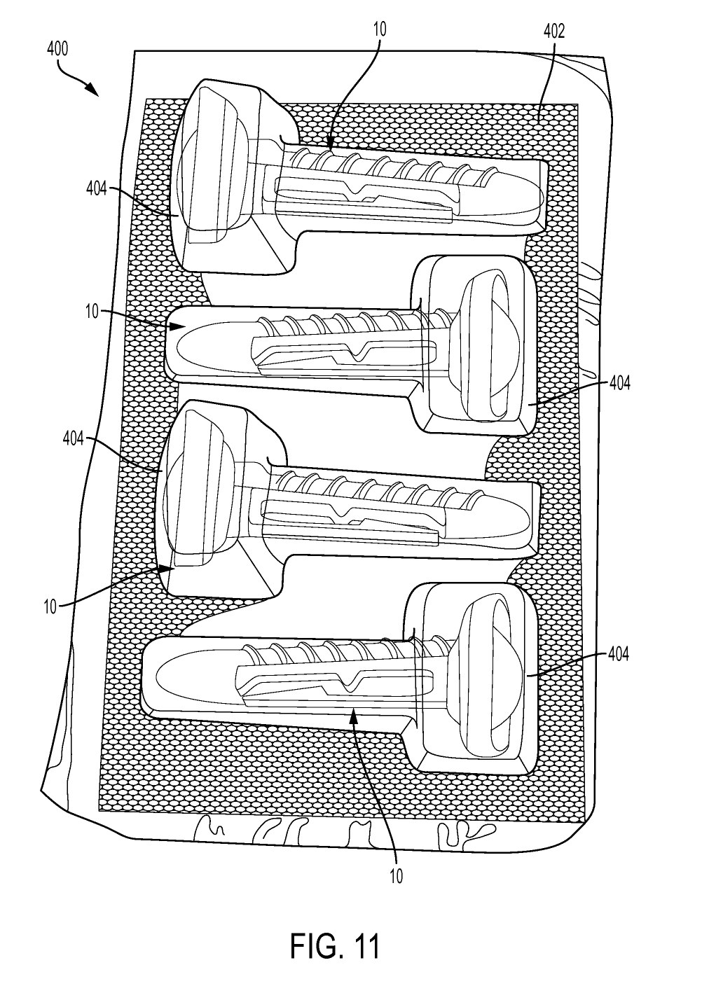

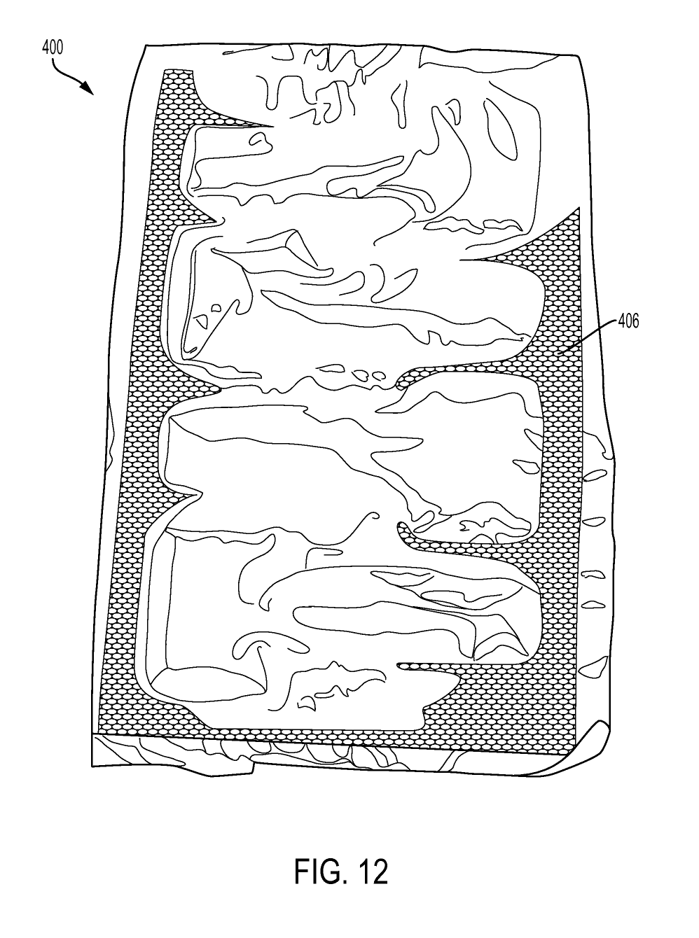

With reference to FIGS. 8-9, scented core 300 comprises a core body 302 that contains a fragrance that will be emitted over time once exposed to the air, and that is dispersed most effectively through the passage of air over the surface thereof. The core body 302 includes a bottom surface 304 that has a bored opening 306 formed therein, and a pair of opposed flanges 308, 310 extending about a portion of the bottom surface's periphery. Scented core 300 is interconnected to support frame 100 by pressing the core down such that bored opening 306 securely receives post 118 therein and flanges 308 and 310 snap over and securely engage the edges of center region 120. Once interconnected, small air passages exist between the interior surface of wall 110 and scented core 300 such that air from the air vents will pass through the openings and be directed over scented core 300 to more effectively disperse the fragrance from scented core 300.

As air freshener 10 is intended to be placed on a louver to an air vent in an automobile, and as is apparent from the accompanying drawings and description, odor absorber 200 is positioned proximally relative to scented core 300 when installed on a louver. Thus, the air passing through the air vent will first pass over odor absorber 200 prior to passing over scented core 300. Therefore, at least some scented particles in the airstream passing through the air vent will be absorbed by odor absorber 200 prior to the air the passing over scented core 300 and dispersing its fragrance into the automobile's cabin.

Because the fragrance in each air freshener 10 begins to disperse once exposed to the air, each is packaged for sale in a package 400 that preserves the fragrance as illustrated. When sold in a package of two or more air fresheners, such as package 400, each air freshener 10 is individually sealed. Package 400 comprises a clear plastic front portion 402 that includes a plurality of bubbles or pockets 404 shaped to conform to and receive a single air freshener 10 therein, and a foil backing 406 that seals the packaging and protects each air freshener 10 from exposure to the outside air. Each air freshener 10 is positioned length-wise in a respective bubble 404 and to remove one from the package a user merely presses downwardly on the bubble 404 near the tip or end of a leg 102/104 to puncture the foil backing 406 directly beneath the air freshener 10 and remove the air freshener 10 from packaging 400 while leaving the remaining air fresheners securely sealed and protected by packaging 400. To further assist in preventing the foil backing 406 from tearing or otherwise exposing the air fresheners intended to sty packaged, the areas of foil backing 406 directly behind the bubbles 404 are no reinforced, while the areas between the bubbles are reinforced, thus making it more difficult to puncture or tear that area of the foil backing. Thus, a multi-pack of air fresheners 10 can be effectively stored within the glove box or other compartment within a car or elsewhere with the unused air fresheners not losing their fragrance once one of them is removed from packaging 10.

What is claimed is:

1. An air freshener for use in an automobile through connection to an air vent in the automobile, the air freshener comprising:
a. first and second legs extending in spaced relation to one another, each having a proximal end;
b. a first air freshening member attached to said first leg;
c. an air freshening member support frame attached to said first and second legs at the proximal ends thereof; and
d. a second air freshening member attached to said air freshening member support frame.

2. The air freshener according to claim 1, wherein said first leg comprises a distal end opposite said proximal end and a first post extending outwardly therefrom in a direction away from said second leg.

3. The air freshener according to claim 2, wherein said first air freshening member comprises an elongated strip of material having a distal end in which a pocket is formed and a first opening formed therein, said pocket positioned in engaged relation to said distal end of said first leg and said first opening being engaged by said first post.

4. The air freshener according to claim 2, wherein said first leg comprises a second post extending outwardly therefrom in a direction away from said second leg and in spaced relation to said first post.

5. The air freshener according to claim 4, wherein first air freshening member comprises a second opening formed therein, said second opening being engaged by said second post.

6. The air freshener according to claim 1, wherein said support frame comprises an exterior wall having an inwardly facing surface, a bridge extending across said exterior wall and connected to its said inwardly facing surface, and at least one opening defined by said bridge and said exterior wall

7. The air freshener according to claim 6, wherein said bridge comprises a post extending outwardly therefrom.

8. The air freshener according to claim 7, wherein said second air freshening member comprises an opening formed therein that is positioned in engaged relation to said post formed on said bridge.

9. The air freshener according to claim 6, wherein said bridge comprises a center region that is spaced from said exterior wall.

10. The air freshener according to claim 9, wherein said second air freshening member comprises a core body having a bottom surface in which said opening is formed and a pair of oppositely positioned flanges extending outwardly therefrom and that forcingly engage said center region, thereby interconnecting said second air freshening member to said core body.

11. The air freshener according to claim 1, wherein said first and second legs are resiliently biased relative to one another for permitting selective variation of the distance separating them.

12. The air freshener according to claim 1, wherein said first and second legs each include inwardly facing surfaces on which at least one barb is formed.

13. The air freshener according to claim 1, wherein said first air freshening member comprises an odor absorbing substance.

14. The air freshener according to claim 1, wherein said second air freshening member comprises an fragrant scent emitting substance.

15. A system comprising a package in which at least two air fresheners are contained, comprising:
a. each of said at least two air fresheners comprising an elongated leg having a pointed distal end; and
b. said package comprising:
i. a cover member having a plurality of bubbles formed therein each of which is sized, shaped and adapted to receive one of said at least two air fresheners therein;
ii. a sealing member composed of a material susceptible to being punctured by said pointed distal end of said air fresheners and extending in sealed relation to said cover member and securely and sealingly enclosing each of said plurality of bubbles, wherein each said air freshener is sealingly enclosed and contained within a respective bubble independent of all other of said air fresheners, whereby each of said at least two air fresheners remains sealingly contained within its respective bubble when another of said air fresheners is removed from its respective bubble.

16. The system of claim 15, wherein said sealing member is composed of foil.
